(19) United States
(12) Patent Application Publication
(10) Pub. No.: US 2007/0244988 A1
(43) Pub. Date: Oct. 18, 2007

(54) Method for searching communications addresses

(76) Inventor: Chia-Hung Tsai, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/735,495

(22) Filed: Apr. 16, 2007

(30) Foreign Application Priority Data
Apr. 17, 2006 (TW) 095113661

(51) Int. Cl. G06F 15/16

(52) U.S. Cl. 709/217

(57) ABSTRACT

A method for searching communications addresses is used in a communications device having an address book recording a plurality of communications addresses of a contact unit. The method includes receiving a command for establishing communications corresponding to the contact unit, selecting a communications address fitting a predetermined rule from the plurality of communications addresses of the contact unit, and establishing communications using the selected communications address.

### BACKGROUND OF THE INVENTION

1. Field of the Invention

The present invention provides a method for establishing a communications link with a contact unit, and more particularly, a method for establishing a communications link with a contact unit according to priorities of the communications addresses or to the time of establishing a communications link with a contact unit.

2. Description of the Prior Art

As the demand for portable electronic devices increases, the related industries expand the functions of the electronic devices, e.g. address book. The address book can be a phone book, an email book, even a contact list of an instant messenger or communications software. Taking a phone book for example, a user stores the contact data of his relatives or friends in a cellular phone or a SIM card. When desiring to contact someone, generally the user will enter the name or a related keyword of the person, and then select the phone number from a possible list shown in the cellular display.

However, in this busy society, many people have several phone numbers. Thus, a user probably stores several different phone numbers for the same person in the phonebook. Some types of cellular phones only can store one phone number for one person so that if there is more than one phone number for one person to store in these types of cellular phones, the user has to use the person's name with a little change to store the additional number. For example, a person A's phone number 1, phone number 2, and phone number 3 are stored in the name of A(office), A(home), and A(dorm) respectively. When the user wants to contact the person, determination of which phone number to dial must be made. If the first dialed phone number does not work, the user has to try again with another phone number until it works. Thus, the user has nothing to aid in raising the probability that the first phone number dialed will work, which is not effective. Additionally, in the prior art, the user has to select the dialed number through the display, which is an inconvenience.

Some types of cellular phones provide functions storing several phone numbers under the same name of a contact person so that the user can store several phone numbers for the same contact person under the same name of the contact person. When the user wants to contact the person, the name is selected, and the cellular phone may provide a list of number from which the user can select. This kind of design is more convenient but the efficiency is not good enough.

### SUMMARY OF THE INVENTION

It is therefore a primary objective of the claimed invention to provide a method for searching communications addresses to solve the problems of the prior art.

The claimed invention provides a method for searching communications addresses used in a communications device, the communications device comprising an address book having a plurality of contact units. The method includes receiving a command for establishing a communications link, the command designating a particular contact unit from the plurality of contact units, the particular contact unit having a plurality of communications addresses. The communications device then selects a communications address according to a predetermined rule from the plurality of communications addresses and uses the selected communications address to establish the communications link.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method for establishing a communications link with a contact unit according to the priorities of the communications addresses of the first embodiment of the present invention.

FIG. 2 is a flowchart illustrating a method for establishing a communications link with a contact unit according to the time establishing a communications links of the second embodiment of the present invention.

### DETAILED DESCRIPTION

The present invention provides a method for searching communications addresses. One of the embodiments of the present invention takes a phonebook of a mobile communications device as an example. However, the present invention can be applied to not only the phonebook but also contact books of other kinds such as email-addresses, and contact lists for an instant messenger or communicating software. In the present embodiment, a user first stores several phone numbers of a contact person in the phonebook of the cellular phone, and sets a predetermined rule to each phone number. When the user wants to contact a person having several phone numbers, it is not necessary to try each phone number. Instead, only the name of the person needs to be selected by the user and the cellular phone will automatically select a phone number with the highest priority according to the predetermined rule.

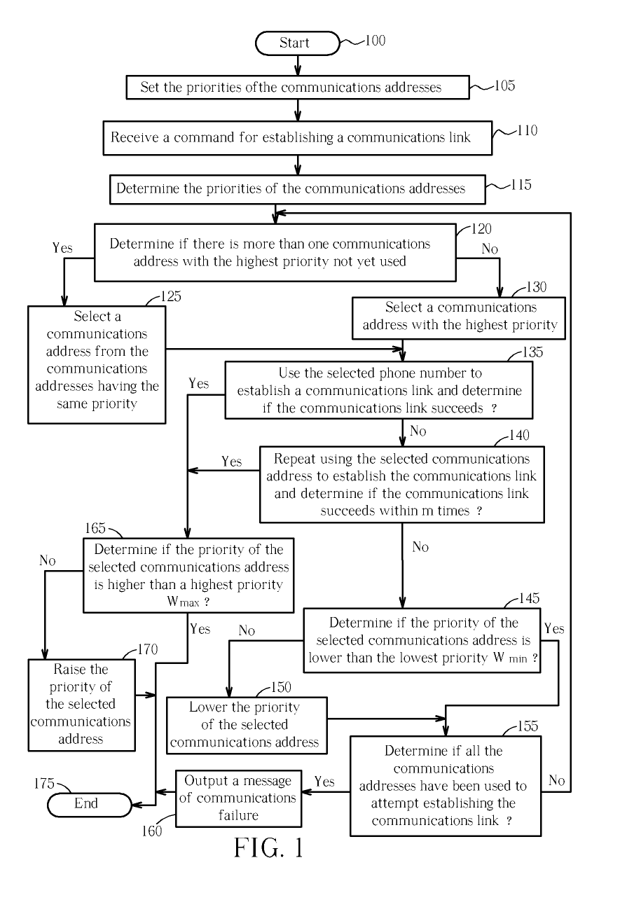

Please refer to FIG. 1. The flowchart of FIG. 1 illustrates a method of the present invention for contacting a contact unit according to the priorities of the communications addresses. The flowchart of FIG. 1 includes the following steps:

Step 100: Start;

Step 105: Set the priorities of the plurality of the communications addresses of a contact unit in a communications device;

Step 110: Receive a command for establishing a communications link with the contact unit without designating a communications address;

Step 115: Check the priorities of the plurality of the communications addresses of the contact unit;

Step 120: Determine if there is more than one communications address with the highest priority from the communications addresses of the contact unit not yet used for establishing the communications link in response to the command; if so, continue with step 125; if not, continue with step 130;

Step 125: Select a communications address from the communications addresses having the same priority according to a predetermined rule and continue with step 135;

Step 130: Select a communications address with the highest priority from the communications addresses not yet used of the contact unit in response to the command;

Step 135: Use the selected phone number to establish a communications link with the contact unit and determine if the communications link succeeds; if so, continue with step 165; if not, continue with step 140;

Step 140: Repeat using the selected communications address to establish the communications link with the contact unit and determine if the communications link succeeds within m times; if so, continue with step 165; if not, continue with step 145;

Step 145: Determine if the priority of the selected communications address is equal to the lowest priority Wₘᵢₙ; if so, continue with step 155; if not, continue with step 150;

Step 150: Lower the priority of the selected communications address;

Step 155: Determine if all the communications addresses of the contact unit have been used to attempt establishing the communications link with the contact unit; if so, continue with step 160; if not, continue with step 120;

Step 160: Output a message of communications failure and continue with step 175;

Step 165: Determine if the priority of the selected communications address is higher than a highest priority Wₘₐₓ; if so, continue with step 175; if not, continue with step 170;

Step 170: Raise the priority of the selected communications address;

Step 175: End.

In the first embodiment of the present invention, a user first sets the default priorities of the plurality of the communications addresses of the contact unit in step 105. For example, a user can set the default priorities of the plurality of the phone numbers (communications addresses) 1 to N of a contact person. When the user wants to make a phone call to the contact person, all that needs done is to select the stored name of the contact person because the cellular phone, in step 110, merely receives a command for establishing a communications link with the contact person, and the user does not search or designate a specific number from the contact person's phone numbers 1 to N. In step 115, after the cellular phone receives the command for establishing the communications link, the cellular phone checks the priorities of all the phone numbers 1 to N and selects the phone number with the highest priority with which to attempt to establish a communications link.

If there is only one phone number of the contact person's phone numbers having a highest priority, the cellular phone, in step 130, selects the phone number having the highest priority to attempt to establish a communications link. If there is more than one phone number having the highest priority, the cellular phone, in step 125, further selects a phone number according to a predetermined rule such as selecting randomly one of the phone numbers sharing the highest priority or selecting the communications address most recently successful in establishing a communications link with the contact unit from the phone numbers having the same highest priority.

In step 135, the cellular phone attempts to use the selected phone number to establish a communications link with the contact person and determines if the communications link works. For convenience, the phone number that the cellular phone selects to attempt to establish a communications link will be referred to here as phone number 1. Phone number 1 can be generated in step 125 and 130. If using phone number 1 cannot establish the communications link, the cellular phone, in step 140, attempts to redial phone number 1. If the communications link is not established after phone number 1 is repeatedly dialed for a predetermined number of times m, if the priority of phone number 1 is not equal to the lowest priority Wₘᵢₙ, the priority of phone number 1 is lowered in step 150. In this way when the user attempts to establish a communications link with the same contact person next time, the priority of the phone number 1 has been lowered.

When the communications link is still not established after phone number 1 is repeatedly dialed for m times and the priority of phone number 1 is the lowest one Wₘᵢₙ, the priority of phone number 1 is not lowered anymore. The lowest priority Wₘᵢₙ is set to be 0 or another value. In the following step 155, if all the phone numbers 1 to N have not been used for attempting to establish a communications link, the cellular phone executes step 120 and selects a phone number having the highest priority among the other phone numbers 2 to N not yet used. When all the phone numbers 1 to N have been used to establish the communications link but failed, the cellular phone shows the message of communications failure in step 160, informing the user that none of the phone numbers of the contact person can establish a communications link.

On the other hand, in step 135, when the cellular phone attempts to use phone number 1 to establish the communications link for the first time and the communications link works, or in step 140, the cellular phone establishes a communications link during repeated attempts at using phone number 1 within m attempts, the cellular phone, in step 165, determines if the priority of phone number 1 is equal to the highest priority Wₘₐₓ which can be set as any value, preferably higher than the lowest priority Wₘᵢₙ. Each time using the phone number 1 successfully establishes a communications link, while the priority of phone number 1 is lower than the highest priority Wₘₐₓ, the cellular phone, in step 170, raises the priority of phone number 1 so that when the next time the user attempts to contact the same contact person, the selecting sequence of phone number 1 has been raised. When using phone number 1 to establish a communications link successfully while the priority of phone number 1 is the highest priority Wₘₐₓ, the priority of phone number 1 is not raised again.

In the first embodiment of the present invention, when the user wants to contact a contact person having several phone numbers, selection of the name of the contact person without checking each phone number of the contact person is all that is necessary for the user to do to place the call. The cellular phone automatically selects a phone number according to the priorities of the phone numbers. The user stores several phone numbers of the contact person in the phone book of the cellular phone, and sets a default priority to each phone number. In the first embodiment of the present invention, when a phone number is used to establish a successful communications link, the priority of the phone number is raised incrementally until reaching the highest priority value Wₘₐₓ, and when a phone number fails to be used to establish a successful communications link after being attempted for a predetermined number of times, the priority of the phone number is lowered incrementally until reaching the lowest priority value Wₘᵢₙ. Therefore, a priority value can reflect a success rate of dialing with a phone number. The phone number having the higher priority has the precedence to be selected to establish a communications link. The present invention can solve the inconvenience of attempts at using each phone number caused by the prior art, quicken the dialing speed, and increase the success rate of establishing a communications link.

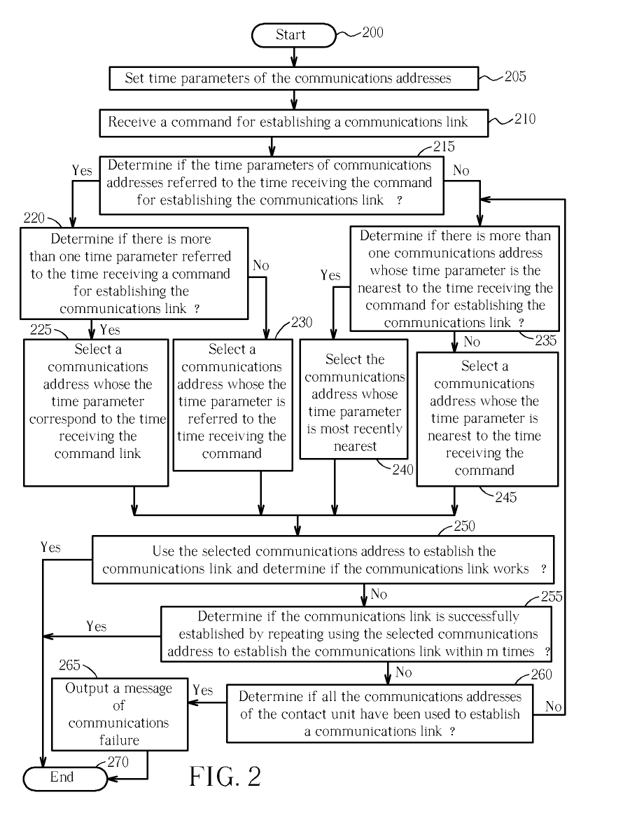

Please refer to FIG. 2. The flowchart in FIG. 2 illustrates a method for contacting a contact unit according to the time of establishing a communications link of a second embodiment of the present invention. The flowchart in FIG. 2 includes the following steps:

Step 200: Start;

Step 205: Set time parameters related to a plurality of the communications addresses of a same contact unit in a communications device;

Step 210: Receive a command for establishing a communications link with the contact unit without designating a communications address;

Step 215: Determine if the time parameters of communications addresses of the contact unit not yet used to establish the communications link in response to the current command are referred to the time of receiving the command for establishing the communications link; if so, continue with step 220; if not, continue with step 235;

Step 220: Determine if there is more than one time parameter is referred to the time of receiving a command for establishing the communications link from the communications addresses of the contact unit not yet used to establish the communications link in response to the current command; if so, continue with step 225; if not, continue with step 230;

Step 225: Select a communications address according to a predetermined rule from the communications addresses whose the time parameters are referred to the time of receiving the command for establishing the communications link and continue with step 250;

Step 230: From the communications addresses of the contact unit not yet used in response to the current command to establish the communications link, select a communications address whose the time parameter is referred to the time of receiving the command for establishing the communications link and continue with step 250;

Step 235: From the communications addresses of the contact unit not yet used to establish the communications link, determine if there is more than one communications address whose time parameter is the nearest to the time of receiving the command for establishing the communications link; if so, continue with step 240; if not, continue with step 245;

Step 240: From the communications addresses whose the time parameters are nearest to the time of receiving the command for establish the communications link, select the communications address whose time parameter is most recently nearest to the time of receiving the command for establishing the communications link and continue with step 250;

Step 245: From the communications addresses of the contact unit not yet used to establish the communications link, select a communications address whose the time parameter is nearest to the time of receiving the command for establishing the communications link and continue with step 250;

Step 250: Use the selected communications address to establish the communications link with the contact unit and determine if the communications link works; if so, continue with step 270; if not, continue with step 255;

Step 255: With the selected communications address, repeat attempts at establishing the communications link with the contact unit; determine if the communications link is successfully established during repeated dialing of the selected communications address to establish the communications link within a number of times m; if so, continue with step 270; if not, continue with step 260;

Step 260: Determine if all the communications addresses of the contact unit have been used to attempt to establish a communications link with the contact unit in response to the current command; if so, continue with step 265; if not, continue with step 235;

Step 265: Output a message of communications failure and continue with step 270;

Step 270: End.

In the second embodiment of the present invention, the user sets time parameters of a plurality of communications addresses of a same contact unit according to the time characteristic of a communications address of the contact unit in step 205. For example, in the phonebook, the user can set time parameters 1 to N corresponding to a contact person's phone numbers 1 to N with which the contact person can be contacted. If the contact person uses phone number 1 most frequently between 8 to 11:45 a.m., the corresponding time parameter 1 is set to the time period from 8 to 11:45 a.m. Or, time parameter 1 of phone number 1 can be set at any specific time, for example, 10 a.m.

When the user attempts to make a phone call to the contact person, all he or she has to do is select the contact person's name. In this way, the cellular phone, in step 210, merely receives the command from the user for contacting the contact person without a designated phone number so that in steps 215, 220, and 235, the cellular phone determines if time parameters 1 to N are referred to or are near to the time of receiving the command for contacting the contact person. If the user attempts to contact the contact person at a specific time, when there is more than one time parameter corresponding to the time of receiving the command for contacting the contact person from the time parameters 1 to N ( for example, the time receiving the command is 10 a.m., the parameter 1 of phone number 1 is set for 8 a.m. to 11 a.m., and the parameter 2 of phone number 2 is set for 8 a.m. to 5 p.m.), in step 225, the cellular phone selects a phone number according to a predetermined rule, for example, randomly selecting a phone number from the phone numbers whose parameters correspond to the time receiving the command, or selecting the phone number most recently used successfully at contacting the contact person ( for example, between phone numbers 1 and 2, select phone number 1 because it was most recently successful at contacting the contact person).

When there is only one phone number whose parameter is referred to the time of receiving the command, the cellular phone, in step 230, selects that phone number. When there is not any phone number whose time parameter is referred to the time of receiving the command but more than one phone number whose time parameter is nearest to the time of receiving the command, for example, time parameter 1 of phone number 1 is set for 11 a.m. to 2 p.m., time parameter 2 of phone number 2 is set for 6 p.m. to 9 p.m., and the command is issued at 4 p.m., the cellular phone, in step 240, selects a phone number whose time parameter is set at a later time period (in this example, phone number 2). When there is not any phone number whose time parameter is referred to the time receiving the command but only one phone number whose time parameter is nearest to the time receiving the command, the cellular phone, in step 245, selects the phone number whose time parameter is nearest to the time of receiving the command.

In step 250, the cellular phone attempts to use the selected phone number to contact the contact person, and determines if the communications link is established. For brevity, phone number 1 represents the phone number used to establish the communications link in step 250, which can be generated in step 225, 230, 235, or 245. If the communications link is not established with phone number 1, in step 255, the cellular phone attempts to repeat dialing of the phone number 1. In the situation that the communications link is not established after the dialing is repeated for a predetermined number of times m, in the following step 260, the cellular phone determines if all the phone numbers 1 to N have been used to establish the link in response to the command. If not, the process continues with step 235 again while selecting a phone number whose time parameter is nearest to the time of receiving the command from phone numbers 2 to N. When all phone numbers 1 to N have been used to attempt to establish the communications link and the communications link is still not established, in step 265, the cellular phone shows a message of communications failure to inform the user that all the phone numbers related to the contact person are unable to establish the communications link.

In the second embodiment of the present invention, when the user wants to contact a contact person having several phone numbers, selection of the stored name of the contact person is all a user is required to do and the cellular phone automatically selects a phone number according to the time parameters of phone numbers and the time of receiving the command for establishing the communications link. The user stores the several phone numbers of the contact person in the phone book of the cellular phone and sets the time parameters to each phone number according to its time characteristics. The time parameters are set to refer to a time period such as 8 to 12, 9 to 17, or to a time moment such as 8, 12, 17. Because a time parameter reflects a corresponding phone number is most frequently used between the time period referring to the time parameter, the second embodiment of the present invention selects the most probable phone number to dial successfully according to the time parameters and the time of receiving the command for establishing the communications link. Thus, the second embodiment of the present invention solves the inconvenience of the prior art of a user attempting each phone number, shortens the dialing time, and increases the success rate of establishing the communications link.

In the present invention, the communications devices are cellular phones, PDAs, or other devices with communications functions. The contact unit is a contact person or an institution. The communications address is a phone number or an email address. The present invention sets the priorities and/or time parameters of the communications addresses of cellular phones, SIM cards, or memory cards of PDAs.

In the prior art, when a user wants to contact a contact unit having several communications addresses, he or she has to determine which communications addresses to select by themselves so that it is not effective. Compared with the prior art, the present invention provides a method for searching communications addresses according to a predetermined rule, which selects the communications address according to the priorities or the time parameters, so that the efficiency is increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for searching communications addresses used in a communications device, the communications device comprising an address book having a plurality of contact units, the method comprising:
receiving a command for establishing a communications link, the command designating a particular contact unit from the plurality of contact units, the particular contact unit comprising a plurality of communications addresses;
the communications device selecting a communications address according to a predetermined rule from the plurality of communications addresses in the particular contact unit; and
using the selected communications address to establish the communications link.

2. The method of claim 1 wherein the communications device selecting the communications address according to the predetermined rule from the plurality of the communications addresses comprises selecting a communications address having a highest priority.

3. The method of claim 2 further comprising setting priorities for the plurality of communications addresses of the particular contact unit.

4. The method of claim 3 wherein the priorities for the plurality of communications addresses of the particular contact unit are set according to a user's preference.

5. The method of claim 3 further comprising for each of the plurality of communications addresses of the particular contact unit, counting a number of times of successfully establishing the communications link to set corresponding priorities for the plurality of communications addresses.

6. The method of claim 5 wherein counting the number of times of successfully establishing the communications link comprises counting a number of attempts to establish the communications link and a number of failures to establish the communications link.

7. The method of claim 2 wherein when at least two communications addresses of the plurality of communications addresses of the particular contact unit have a same priority, the communications device randomly selects one of the at least two communications address with the same priority to establish the communications link.

8. The method of claim 2 wherein when at least two communications addresses of the plurality of communications addresses of the particular contact unit have a same priority, the communications device selects one from the at least two communications address most recently used to successfully establish the communications link.

9. The method of claim 2 further comprising when the communications link cannot be established with the communications address having the highest priority, the communications device selecting the communications address having the second highest priority of the particular contact unit to establish the communications link.

10. The method of claim 9 further comprising if the communications device uses the communications address having the second highest priority to establish the communications link, priority of the communications address having the second highest priority is raised.

11. The method of claim 2 further comprising if the communications device cannot use the communications address having the highest priority from the particular contact unit to establish the communications link, priority of the communications address having the highest priority from the particular contact unit is lowered.

12. The method of claim 1 wherein the communications device selecting the communications address according to the predetermined rule from the plurality of communications addresses comprises selecting a communications address base on the time when the command for establishing the communications link is received.

13. The method of claim 12 further comprising setting corresponding relationships between time parameters and different communications addresses of the particular contact unit.

14. The method of claim 13 wherein the corresponding relationships between the time parameters and the different communication addresses of the particular contact unit are set according to a user's preference.

15. The method of claim 13 wherein when at least two communication addresses correspond to the same time parameter referred to the time the command for establishing the communications link is received, the communications device randomly selects one of the at least two communications addresses for establishing the communications link.

16. The method of claim 13 wherein when at least two communication addresses correspond to the same time parameter referred to the time the command for establishing the communications link is received, the communications device selects the most recently successfully used one from the at least two communication addresses for establishing the communications link for establishing the communications link.

17. The method of claim 13 wherein when no time parameter of the communication addresses referred to the time the command for establishing the communications link, the communications device selects the communications addresses having a time parameter nearest to the time the command for establishing the communications link is received.

18. The method of claim 1 further comprising setting the predetermined rule in a SIM card or memory card.

19. The method of claim 1 further comprising when the communications link cannot be established with the communications address according to the predetermined rule, repeating attempts to establish the communications link using the communications address according to the predetermined rule for a predetermined number of times.

20. The method of claim 1 further comprising if the communication device cannot use any communications addresses of the particular contact unit to establish the communications link, outputting a message of communications failure.

21. The method of claim 1, wherein the communications device is a mobile phone or a PDA.
